(19) United States
(12) Patent Application Publication
(10) Pub. No.: US 2005/0215191 A1
(43) Pub. Date: Sep. 29, 2005

(54) Air intake duct

(75) Inventor: Hitoshi Kino, Nishikasugai-gun (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD.

(21) Appl. No.: 11/067,680

(22) Filed: Mar. 1, 2005

(30) Foreign Application Priority Data
Mar. 3, 2004 (JP) P2004-059456

(51) Int. Cl. B60H 1/00

(52) U.S. Cl. 454/143

(57) ABSTRACT

An air intake duct is disposed in an engine compartment and has wall sections for forming an air passage for introducing air into a combustion chamber of an engine. A support member is disposed on at least a portion of the wall sections, wherein the support member is shrunk when a compressive force of a predetermined value or more is applied from the outside to the wall sections, and at least a portion of the support member is elastically restored when the compressive force decreases.

This application is based on Japanese Patent Application No. 2004-059456, which is incorporated herein by reference.

### BACKGROUND OF THE INVENTION

1. Field of the Invention

The present invention relates to an air intake duct for introducing outside air into a combustion chamber of an engine.

2. Description of the Related Art

An air intake duct is disposed on a most upstream side of an induction system for allowing the outside and a combustion chamber to communicate with each other (e.g., refer to JP2003-314393 Å). The air intake duct has a wall section for partitioning an air passage. An inlet port section is formed at an upstream end of the wall section. The inlet port section is open in the vicinity of a front edge of an engine compartment. The inlet port section is secured to an upper portion of a radiator upper support of a radiator. Meanwhile, a downstream end of the wall section is connected to a dirty side (an upstream side of an air element) of an air cleaner.

As described above, the inlet port section is secured to the upper portion of the radiator upper support and is disposed immediately below a hood panel. For this reason, the inlet port section frequently has a flat shape. Accordingly, included among the problems are the rectification of an air current, the securing of rigidity, the occurrence of intake noise due to the membrane vibration of upper and lower walls, and deformation due to intake negative pressure. In this respect, ribs connecting the upper and lower walls are disposed in the inlet port section of JP-A-11-229982.

However, the inlet port section is disposed immediately below the hood panel. For this reason, it is conceivable that when the hood panel is closed, the hood panel and the inlet port section interfere with each other, causing damage to the ribs. Also, it is conceivable that the ribs may become damaged during the operation of assembling the air intake duct or the like or a light collision of the vehicle. The ribs which have been damaged once are not restored to their original state. Accordingly, the inlet port section becomes crushed. If the inlet port section becomes crushed, the intake sectional area becomes small. For this reason, there is a possibility that it becomes impossible to supply a desired amount of outside air to the combustion chamber.

### SUMMARY OF THE INVENTION

The air intake duct of the invention has been completed in view of the above-described problems. Accordingly, an object of the invention is to provide an air intake duct which is capable of supplying a desired amount of outside air to the combustion chamber even after at least apart of the wall section such as the inlet port section has been compressed.

To overcome the above-described problems, in accordance with the invention there is provided an air intake duct having a wall section in which an air passage for introducing air is formed, characterized by comprising a support member provided a part of the wall section, wherein the support member is elastically deformable to a compressive force of a predetermined value to the wall section, so that the wall section is resiliently restorable when the compressive force is released.

A support member is disposed on at least a portion of the wall section (e.g., a portion where collision energy is to be consumed). At least a portion of the support member is elastically restorable. For this reason, even if the wall section has been compressed and deformed, at least a portion of the wall section can be restored by making use of the restoring force of the support member. Namely, the passage sectional area of the air passage can be made large as compared with the time when the wall section is compressed. Accordingly, it is possible to supply a desired amount of outside air to the combustion chamber.

In addition, even if a collision object has ridden over the hood panel during a collision, at least part of the collision energy is consumed as the elastic deformation energy of support member. For this reason, the impact is alleviated.

Preferably, an inlet port section having a flat cross-sectional shape is disposed at an upstream end of the wall section, and the support member includes a spring member extending in a direction of a short axis of the inlet port section. Namely, in this construction, a spring member is disposed as the support member at the inlet port section disposed at the upstream end of the wall section. According to this construction, the spring member is disposed along the short-axis direction. For this reason, it is possible to easily secure the intake sectional area of the inlet port section even after the inlet port section has been compressed and deformed in the short-axis direction.

Preferably, an inlet port section having a flat cross-sectional shape is disposed at an upstream end of the wall section, and the support member is a rubber member extending in a direction of a short axis of the inlet port section. Namely, in this construction, a rubber member is disposed as the support member at the inlet port section disposed at the upstream end of the wall section. According to this construction, the rubber member is disposed along the short-axis direction. For this reason, it is possible to easily secure the intake sectional area of the inlet port section even after the inlet port section has been compressed and deformed in the short-axis direction.

Preferably, the support member includes a rib member extending along a longitudinal direction of the air passage. According to this construction, turbulence is difficult to occur in the air current in the air passage. For this reason, intake resistance becomes small.

Preferably, a stopper member for suppressing dislocation of the support member is disposed at a portion of the wall section where the support member is disposed. According to this construction, it is possible to suppress the support member from becoming dislocated and entering the downstream side of an induction system due to intake negative pressure. Accordingly, it is possible to effect, among others, the suppression of intake resistance from becoming large.

Preferably, the stopper member is disposed around a through ole formed in the wall section, and a cover member for covering the support member and the through hole is disposed.

The inlet port for directly introducing the outside air is in many cases open toward the front side of the vehicle. The reason for this is to introduce cool outside air (outside air having a large air density) so as to enhance the combustion efficiency in the combustion chamber.

In contrast, the through hole is formed by using as a reference the portion where the stopper member is disposed. For this reason, it is conceivable that relatively warm air (outside air having a small air density) inside the engine compartment enters the air passage through the through hole via a different root from the inlet port. Namely, it is conceivable that the combustion efficiency in the combustion chamber becomes low.

In view of this aspect, a cover member is provided in this construction. The support member and the through hole are shielded from the air passage by means of the cover member. Consequently, it is possible to suppress relatively warm air from entering the air passage through the through hole. Hence, according to this construction, it is possible to suppress a decline in the combustion efficiency in the combustion chamber. In addition, according to this construction, since the overall surface of the support member is covered with the cover member, the intake resistance attributable to the shape of the support member becomes small.

Preferably, the cover member is formed of an elastic material. The cover member of this construction is easily compressed and restored. For this reason, at least part of the collision energy can be consumed as the elastically deforming energy of the cover member.

According to the invention, it is possible to provide an air intake duct which is capable of supplying a desired amount of outside air to the combustion chamber even after at least a part of the wall section has been compressed.

### BRIEF DESCRIPTION OF THE DRAWINGS

FIG. 1 is a perspective view of an air intake duct in accordance with a first embodiment;

FIG. 2 is an exploded perspective view of the air intake duct;

FIGS. 3A to 3C are schematic diagrams of that air intake duct prior to a collision (a cross-sectional view taken along line III-III in FIG. 1), during the collision, and after the collision, respectively;

FIG. 4 is a perspective view of the air intake duct in accordance with a second embodiment;

FIG. 5 is an exploded perspective view of that air intake duct;

FIG. 6 is a cross-sectional view taken along line VI-VI in FIG. 4;

FIG. 7 is a cross-sectional view in a short-axis direction of the air intake duct in accordance with a third embodiment;

FIG. 8 is a perspective view of a stopper member of that air intake duct;

FIG. 9 is a cross-sectional view in the short-axis direction of the air intake duct in accordance with a fourth embodiment; and

FIG. 10 is a perspective view of the stopper member of that air intake duct.

### DETAILED DESCRIPTION OF THE PREFERRED EMBODIMENTS

Hereafter, a description will be given of the embodiments of the invention.

### First Embodiment

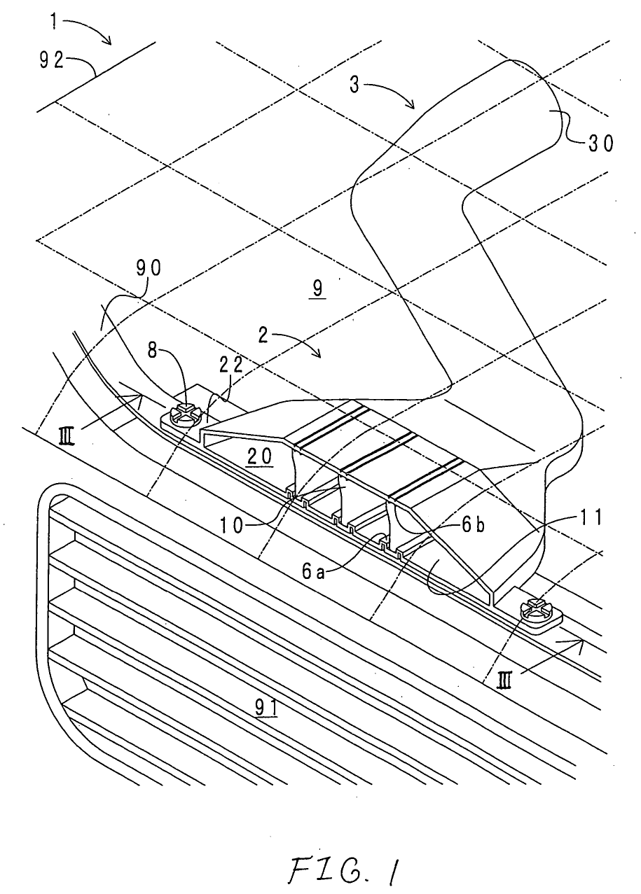

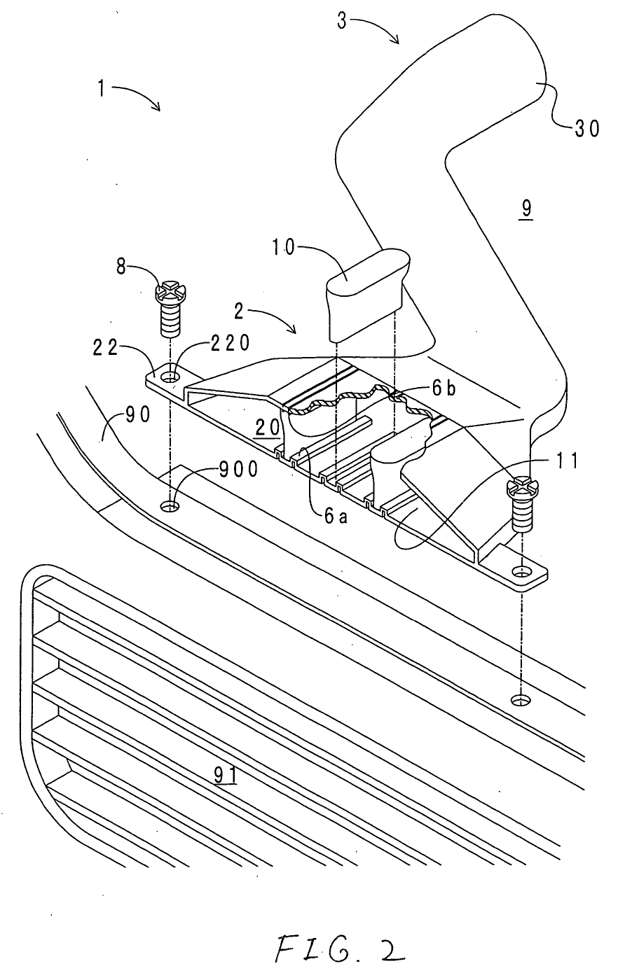

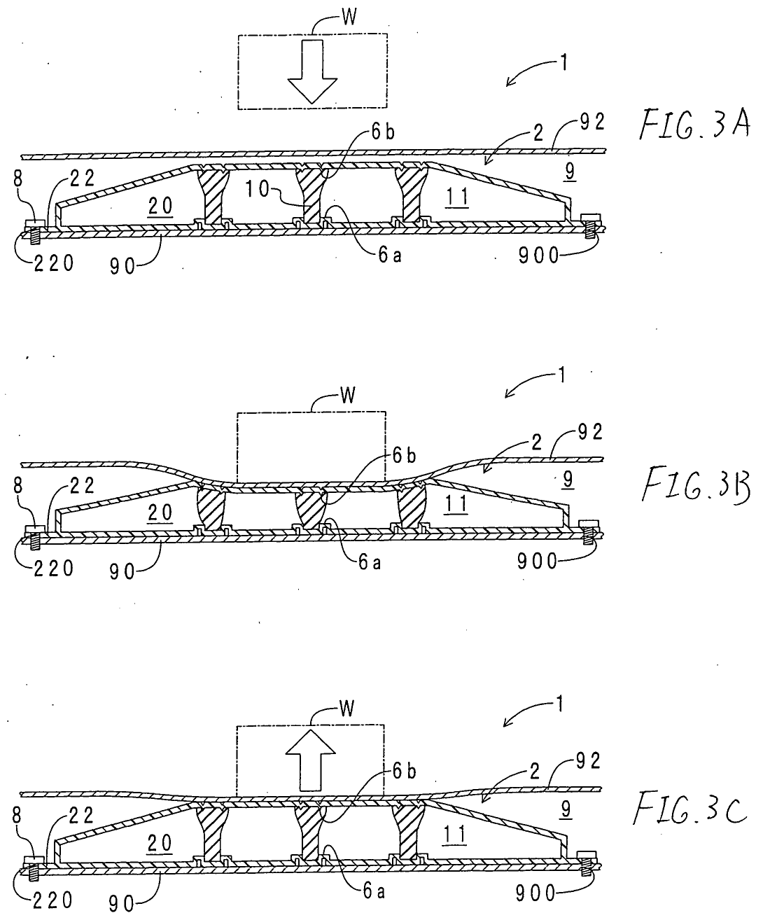

First, a description will be given of the construction of an air intake duct in accordance with a first embodiment of the invention. FIG. 1 shows a perspective view of the air intake duct of this embodiment. It should be noted that a hood panel is shown by a wire frame (shown by chain lines in the drawing) due to the convenience of explanation. FIG. 2 shows an exploded perspective view of the air intake duct. FIG. 3A shows a cross-sectional view taken along line III-III in FIG. 1. As shown in these drawings, an air intake duct 1 is comprised of an inlet port section 2, an air passage section 3, a rib member 10, and stopper members 6a and 6b. It should be noted that a wall section of the invention is made up of the inlet port section 2 and the air passage section 3. Air passages 11 are formed in the interiors of the inlet port section 2 and the air passage section 3.

The inlet port section 2 is formed by injection molding polypropylene (PP). The inlet port section 2 has the shape of a flat trapezoidal tube which is wide in the transverse direction of the vehicle and is flattened downward. A pair of securing pieces 22 are formed outside the tube of the inlet port section 2 at its both ends in the transverse direction of the vehicle. A duct-side securing hole 220 is punched in each of the securing pieces 22.

Meanwhile, a pair of radiator-side securing holes 900 are punched in a metallic radiator upper support 90 disposed at a front edge of an engine compartment 9. The dust-side securing holes 220 and the radiator-side securing holes 900 are vertically aligned. A bolt 8 is passed through each dust-side securing hole 220 and is secured in the radiator-side securing hole 900. The inlet port section 2, i.e., the air intake duct 1, is fixed to the radiator upper support 90 by means of the bolts 8. An inlet port 20 is disposed is disposed inside the tube of the inlet port section 2. The inlet port 20 is open toward the front side of the vehicle, i.e., a radiator grille 91.

The air passage section 3 is formed by injection molding PP. The air passage section 3 continues to a downstream side of the inlet port section 2. The upstream side of the air passage section 3 has the shape of a flat rectangular tube. The downstream side of the air passage section 3 has a hollow cylindrical shape. A downstream end 30 of the air passage section 3 is connected to a dirty side of an air cleaner (not shown).

The stopper members 6a and 6b are formed in the shaped of a rib. The stopper members 6a and 6b are disposed in the longitudinal direction of the air passage 11. Of these, the stopper members 6a are disposed on an upper surface of a lower wall of the inlet port section 2. The stopper members 6b are disposed on a lower surface of an upper wall of the inlet port section 2 in face-to-face relation to the stopper members 6a. These stopper members 6a and 6b, the inlet port section 2, and the air passage section 3 are fabricated by first fabricating by injection molding a lower split body consisting of the stopper members 6a, a lower half of the inlet port section 2, and a lower half of the air passage section 3, by fabricating an upper split body consisting of the stopper members 6b, an upper half of the inlet port section 2, and an upper half of the air passage section 3, and then by joining the lower split body and the upper split body. According thereto, the air intake duct 1 is formed.

The rib members 10 are made of a rubber and connect the upper and lower walls of the inlet port section 2. The rib members 10 are disposed along the longitudinal direction of the air passage 11. In addition, the rib members 10 are arranged in three rows in such a manner as to be juxtaposed in the transverse direction of the vehicle. A lower edge of each rib member 10 is clamped and fixed from both sides in the transverse direction of the vehicle by the pair of stopper members 6a. Meanwhile, the pair of stopper members 6b are press fit to an upper edge of the rib member 10 just like wedges.

Next, a description will be given of the movement of the air intake duct of this embodiment during a collision. FIGS. 3A to 3C are schematic diagrams of the air intake duct of this embodiment prior to a collision, during the collision, and after the collision, respectively.

As shown in FIG. 3A, a collision object W collides against a hood panel 92 from above. As shown in FIG. 3B, the collided portion of the hood panel 92 is crushed and deformed downward due to the collision by the collision object W. The upper wall of the inlet port section 2 is also crushed and deformed downward. In addition, the rib members 10 are compressed and deformed downward and expand in the transverse direction of the vehicle. Through the above-described series of deformations the vertical width of the inlet port section 2 becomes small. That is, the inlet port section 2 collapses. Also, through the above-described series of deformations the collision energy is consumed. When the colliding force becomes small and the colliding force becomes smaller than the restoring force (elastically deforming force), the rib members 10 are restored, as shown in FIG. 3C. When the rib members 10 are restored, the upper wall of the inlet port section 2 is also restored. For this reason, it is possible to secure substantially the same intake sectional area as before the collision. In addition, the collided portion of the hood panel 92 is also pushed upward together with the upper wall of the inlet port section 2. For this reason, the collided portion of the hood panel 92 is also restored partially.

Next, a description will be given of the operation and effects of the air intake duct in accordance with this embodiment. According to the air intake duct 1 of this embodiment, the rib members 10 are elastically restorable. For this reason, even if the inlet port section 2 has been compressed and deformed, the inlet port section 2 can be restored. Accordingly, it is possible to supply a desired amount of outside air to a combustion chamber.

In addition, as shown in FIGS. 3A to 3C referred to above, even if the collision object W has ridden over the hood panel 92 during a collision, part of the collision energy is consumed as the elastic deformation energy of the rib members 10. For this reason, the impact to which the collision object W is subjected is alleviated.

In addition, the stopper members 6a and 6b are disposed in the air intake duct 1 of this embodiment. For this reason, it is possible to suppress the rib members 10 from becoming dislocated and entering the downstream side of the induction system due to intake negative pressure. Accordingly, it is possible to effect, among others, the suppression of intake resistance from becoming large.

In addition, according to the air intake duct 1 of this embodiment, rib members 10 are juxtaposed in parallel in three rows. For this reason, during a collision, collision energy is easily consumed as the elastic deformation energy. In addition, front and rear edges of the rib members 10 are formed into a chamfered, rounded shape. For this reason, turbulence is difficult to occur in the outside air introduced through the inlet port 20. In addition, the rib members 10 extend along the longitudinal direction of the air passage 11. Hence, the rectification effect is high.

### Second Embodiment

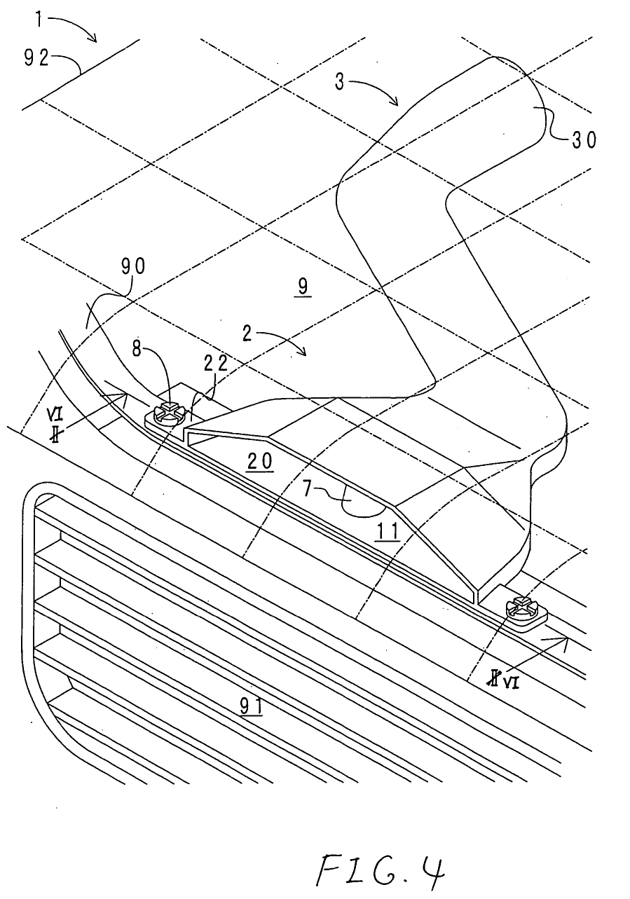

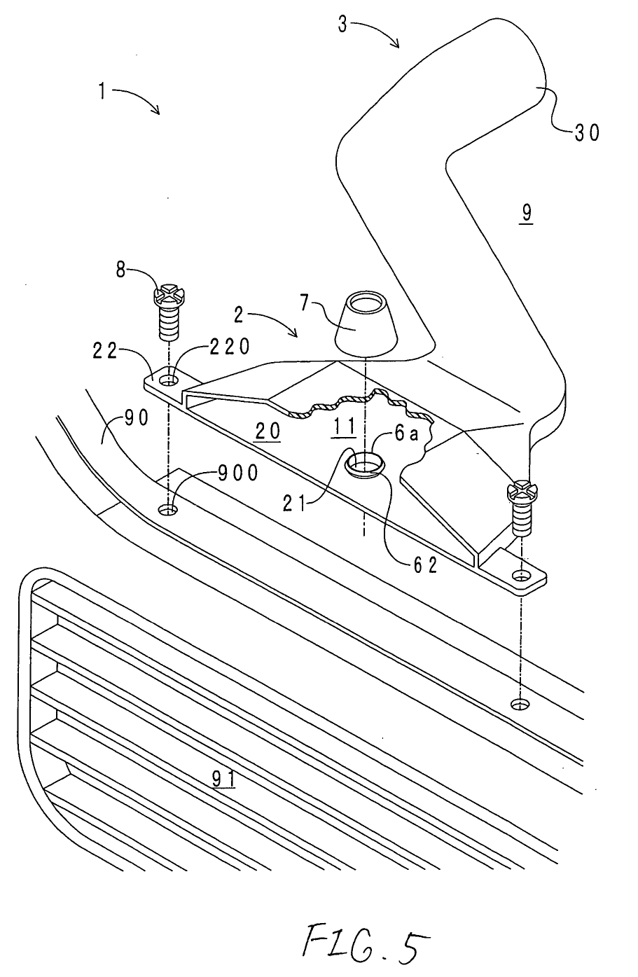

First, a description will be given of the construction of the air intake duct in accordance with a second embodiment of the invention. FIG. 4 shows a perspective view of the air intake duct of this embodiment. It should be noted that portions corresponding to those of FIG. 1 are denoted by the same reference numerals. FIG. 5 shows an exploded perspective view of the air intake duct. It should be noted that portions corresponding to those of FIG. 2 are denoted by the same reference numerals. FIG. 6 shows a cross-sectional view taken along line VI-VI in FIG. 4. It should be noted that portions corresponding to those of FIGS. 3A to 3C are denoted by the same reference numerals.

As shown in these drawings, the stopper member 6a is formed in the shape of an annular rib. A circumferentially continuous engaging pawl 62 is formed on an upper end of the stopper member 6a. The stopper member 6a is provided in such a manner as to project from the lower wall of the inlet port section 2. A through hole 21 is formed on the inner peripheral side of the stopper member 6a. The stopper member 6a has the shape of a short-axis cylinder. The stopper member 6b is provided in such a manner as to project from the upper wall of the inlet port section 2 toward the stopper member 6a. The outer shape of a rubber member 7 has the shape of a hollow truncated cone whose diameter decreases gradually from the lower side toward the upper side. In addition, the rubber member 7 has the shape of a cup which is open toward the lower side. An engaged groove 71 is circumferentially provided at a lower edge of an inner peripheral surface of the rubber member 7. Meanwhile, a recessed portion 70b is provided in a recessed manner in an upper bottom wall of the rubber member 7. The engaging pawl 62 of the stopper member 6a is retained in the engaged groove 71. The stopper member 6b is press fit into the recessed portion 70b. As the stopper member 6a is retained and the stopper member 6b is press fit, the rubber member 7 is secured in the inlet port section 2.

The air intake duct 1 of this embodiment exhibits the operation and effects similar to those of the air intake duct of the first embodiment. In addition, the through hole 21 is formed in the air intake duct 1 of this embodiment. However, the rubber member 7 itself has airtightness. For this reason, the through hole 21 can be shielded from the air passage 11 by the rubber member 7.

### Third Embodiment

The air intake duct in accordance with a third embodiment of the invention differs from the second embodiment in that a spring member is disposed instead of the rubber member. Further, the shapes of the stopper members also differ. Furthermore, a cover member is disposed on an outer peripheral side of the spring member. Accordingly, a description will be given only of the differences.

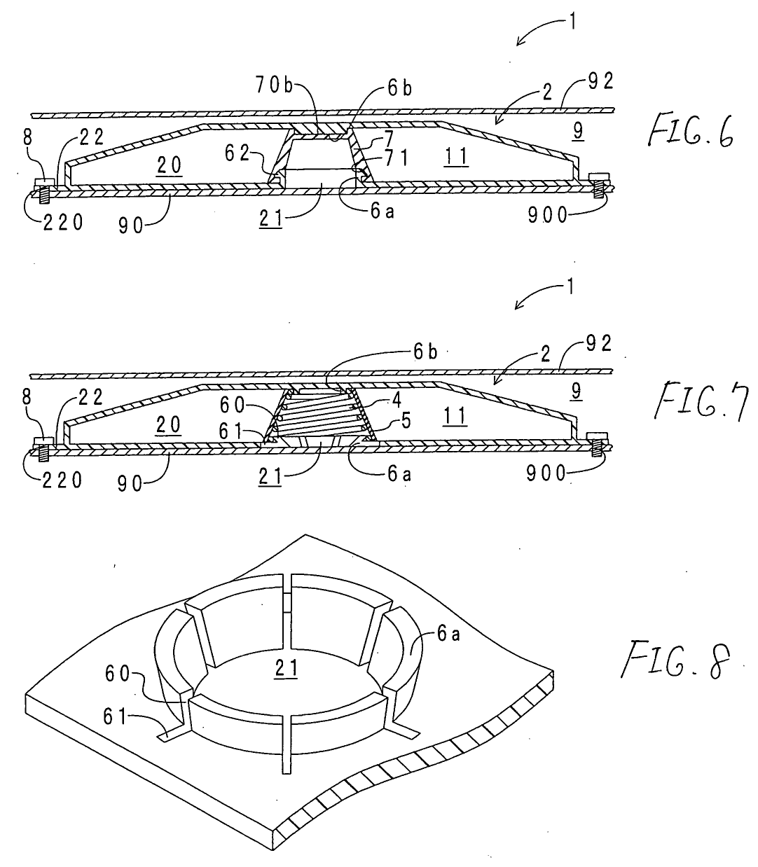

FIG. 7 shows a cross-sectional view in a short-axis direction of the air intake duct in accordance with this embodiment. It should be noted that portions corresponding to those of FIG. 6 are denoted by the same reference numerals. FIG. 8 shows a perspective view of the stopper member of the air intake duct. It should be noted that portions corresponding to those of FIG. 5 are denoted by the same reference numerals. A spring member 4 is made of steel and has the shape of a hollow truncated cone whose diameter decreases gradually from the lower side toward the upper side, as shown in FIG. 7. A rubber-made cover member 5 is disposed on the outer peripheral side of the spring member 4. The cover member 5 has the shape of a hollow truncated cone whose diameter decreases gradually from the lower side toward the upper side.

As shown in FIG. 8, the stopper member 6a has the shape of an annular rib. The stopper member 6a is formed such that its diameter increases gradually from the lower side toward the upper side. Axial slits 60 and radial slits 61 are formed in the stopper member 6a. The axial slit 60 and the radial slit 61 continue in an L-shape. The axial slits 60 and the radial slits 61 are respectively disposed in such a manner as to be spaced apart from each other at intervals of 60° in the circumferential direction, and a total of six slits are provided, respectively. The through hole 21 is formed on the inner peripheral side of the stopper member 6a. A lower-end loop of the spring member 4 is fitted over the stopper member 6a. Meanwhile, the stopper member 6b has the shape of an annular rib. An upper-end loop of the spring member 4 is fitted over the stopper member 6b.

The air intake duct 1 of this embodiment exhibits the operation and effects similar to those of the air intake duct of the first embodiment. In addition, according to the air intake duct 1 of this embodiment, when the spring member 4 is fitted over the stopper member 6a, the stopper member 6a is deformed in the diameter-reducing direction and in the downward direction by the portions of the axial slits 60 and the radial slits 61. For this reason, the assembly of the spring member 4 is facilitated.

In addition, as described above, the stopper member 6a is formed such that its diameter increases gradually from the lower side toward the upper side. Meanwhile, the spring member 4 is formed such that its diameter decreases gradually from the lower side toward the upper side. The inner peripheral diameter of the lower end loop of the spring member 4 is set to be smaller than the outer peripheral diameter of the upper edge of the stopper member 6a. For this reason, the spring member 4 is difficult to come off the stopper member 6a.

In addition, when the spring member 4 is shrunk, the loops making up the spring member 4 are difficult to interfere each other. Namely, as described before, the spring 4 is formed such that its diameter decreases gradually from the lower side toward the upper side. For this reason, the diameter of the upper loop is smaller than that of the lower loop. Accordingly, when the spring member 4 is shrunk, the upper loop is accommodated on the inner peripheral side of the lower loop between vertically adjacent ones of the loops. Since this accommodating operation is effected over the entire length of the spring member 4, the spring member 4 is accommodated in the through hole 21 on the inner peripheral side of the stopper member 6a. Hence, according to the air intake duct 1 of this embodiment, the allowance of the elastic deformation of the spring member 4 becomes large. For this reason, during a collision, the collision energy is easily consumed as the elastic deformation energy.

In addition, the cover member 5 is disposed in the air intake duct 1 of this embodiment. The cover member 5 covers the spring member 4 and the through hole 21. Namely, the cover member 5 isolates the through hole 21 from the air passage 11. For this reason, it is possible to suppress relatively warm air in the engine compartment 9 from entering the air passage 11 through the through hole 21. Accordingly, it is possible to suppress a decline in the combustion efficiency in the combustion chamber. In addition, since the overall surface of the spring member 4 is covered with the cover member 5, the intake resistance attributable to the shape of the spring member 4 becomes small. Furthermore, the cover member 5 is made of rubber which is an elastic material. For this reason, the collision energy can be consumed as the elastic deformation energy by not only the deformation of the spring member 4 but also the deformation of the cover member 5. Namely, the function of the spring member 4 can be assisted by the cover member 5.

### Fourth Embodiment

Differences between the air intake duct in accordance with a fourth embodiment of the invention and the third embodiment lie in the shape of the spring member and the shape of the stopper member on the lower wall side of the inlet port section. Accordingly, a description will be given only of the differences.

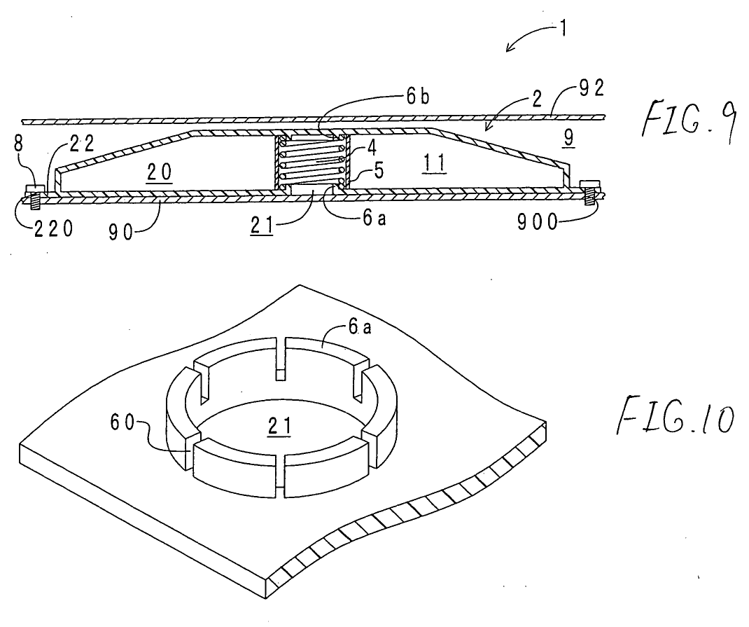

FIG. 9 shows a cross-sectional view in the short-axis direction of the air intake duct in accordance with this embodiment. It should be noted that portions corresponding to those of FIG. 7 are denoted by the same reference numerals. FIG. 10 shows a perspective view of the stopper member of the air intake duct of this embodiment. It should be noted that portions corresponding to those of FIG. 8 are denoted by the same reference numerals. The axial slits 60 are formed in the stopper member 6a, as shown in FIG. 10. The axial slit 60 are disposed in such a manner as to be spaced apart from each other at intervals of 60° in the circumferential direction, and a total of six slits are provided. In addition, the spring member 4 and the cover member 5 have hollow cylindrical shapes. The air intake duct of this embodiment exhibits the operation and effects similar to those of the air intake duct of the first embodiment. In addition, according to the air intake duct of this embodiment, when the spring member 4 is fitted over the stopper member 6a, the stopper member 6a undergoes a reduction in diameter and deformation by the portion of the axial slits 60. For this reason, the assembly of the spring member 4 is facilitated.

A description has been given above of the embodiments of the air intake duct in accordance with the invention. However, the invention is not limited to the above-described embodiments and may be implemented in various forms of modification or improvement which may be carried out by those skilled in the art.

For instance, in the above-described embodiments the inlet port section 2 and the air passage section 3 are formed by the injection molding of PP, by may be formed of PE (polyethylene), PA (polyamide), or the like. In addition, the inlet port section 2 and the air passage section 3 may be fabricated separately and may subsequently be joined together. In addition, the inlet port section 2 and the air passage section 3 may be fabricated integrally by blow molding.

In addition, in the above-described embodiments, the rib members 10, the rubber member 7, and the spring member 4 are assembled to the inlet port section 2 after the molding of the inlet port section 2 and the air passage section 3. However, the rib members 10, the rubber member 7, and the spring member 4 may be assembled to the inlet port section 2 by insert molding simultaneously with the molding of the inlet port section 2 and the air passage section 3.

In addition, in the case where the spring member 4 in the form of a coil spring is used as a support member, the restoring force (elastically deforming force) may be adjusted by the number of coils, coil shape, pitch, wire diameter, material, and the like. Also, in the case where the rubber member 7 and the rib members 10 are used as the support members, the restoring force (elastically deforming force) may be adjusted by the material, thickness, and the like.

In addition, although the spring member 4 in the form of the coil spring is used in the third and fourth embodiments, the shape of the spring member is not particularly limited and may be in the form of a leaf spring, a coned disc spring, or the like.

In addition, as the support members, the rib members 10, the rubber member 7, and the spring member 4 may be used by being combined in parallel or in series. Further, the support members may not connect the upper and lower walls of the inlet port section 2. Namely, a gap may be present between the support member and the upper wall or between the support member and the lower wall. Furthermore, not all of the support members may be restored after the collision. It suffices if a sectional area of the passage sufficient to supply a predetermined amount of outside air to the combustion chamber can be secured in the air passage 11. In addition, an air cylinder, an oil cylinder, or the like may be used as the support member. The reason for this is that the support member is restorable by the elastically deforming force of a fluid in the cylinder.

In addition, although the support member is disposed in the inlet port section 2 in the above-described embodiments, the support member may be disposed in the air passage section 3. Furthermore, the support members may be disposed both in the inlet port section 2 and in the air passage section 3. Namely, the support member may be disposed at a desired portion where the collision energy is to be consumed.

1. An air intake duct comprising:
a wall section in which an air passage for introducing air is formed; and
a support member provided in a part of the wall section,
wherein the support member is elastically deformable to a compressive force of a predetermined value to the wall section, so that the wall section is resiliently restorable when the compressive force is released.

2. The air intake duct according to claim 1, wherein the support member includes a rib member extending along a longitudinal direction of the air passage.

3. The air intake duct according to claim 2, wherein the rib member comprises a rubber.

4. The air intake duct according to claim 1, wherein an inlet port section having a flat cross-sectional shape is disposed at an upstream end of the wall section; and
the support member includes a rubber member extending in a direction of a short axis of the inlet port section.

5. The air intake duct according to claim 4, wherein the rubber member has a hollow shape.

6. The air intake duct according to claim 4, wherein the rubber member has a shape of a truncated cone whose diameter decreases gradually from one side toward another side.

7. The air intake duct according to claim 1, wherein an inlet port section having a flat cross-sectional shape is disposed at an upstream end of the wall section; and
the support member includes a spring member extending in a direction of a short axis of the inlet port section.

8. The air intake duct according to claim 7, wherein a rubber member covers an outer peripheral side of the spring member.

9. The air intake duct according to claim 7, wherein the spring member has a shape of a truncated cone whose diameter decreases gradually from one side toward another side.

10. The air intake duct according to claim 7, wherein the spring member has a cylindrical shape.

11. The air intake duct according to claim 1, further comprising a stopper member for suppressing dislocation of the support member,
wherein the stopper member is disposed at a portion of the wall section where the support member is disposed.

12. The air intake duct according to claim 11, wherein the stopper member is disposed around a through hole formed in the wall section; and
the air intake duct further comprises a cover member for covering the support member and the through hole.

13. The air intake duct according to claim 12, wherein the cover member is formed of an elastic material.

14. The air intake duct according to claim 11, wherein one end of the support member is clamped and fixed from both sides in the transverse direction of a vehicle by the pair of stopper members.

15. The air intake duct according to claim 11, wherein one end of the support member is press fitted by the pair of stopper members just like wedges.

16. The air intake duct according to claim 1, wherein the air intake duct is formed by joining a lower split body thereof and a upper split body thereof.

17. The air intake duct according to claim 1, wherein an edge of the support member in a longitudinal direction of the air passage is formed into a rounded shape.

18. An air intake duct comprising:
a wall section in which an air passage for introducing air is formed, and having a flat cross-sectional shape; and
a hollow support member provided at least in a part of the wall section, so as to extend in a direction of the inlet part section.

19. The air intake duct according to claim 18, further comprising a spring member provided inside of the hollow support member.

20. The air intake duct according to claim 18, wherein the hollow support member has a shape of a truncated cone whose diameter decreases gradually from one side toward another side.

21. The air intake duct according to claim 18, wherein the hollow support member has a cylindrical shape.
